(19) United States
(12) Patent Application Publication
(10) Pub. No.: US 2009/0205847 A1
(43) Pub. Date: Aug. 20, 2009

(54) Multi-purpose removeable tool and storage attachment

(76) Inventors: Scott Benoit, Northfield, NH (US); Jack McGourty, Epsom, NH (US)

Correspondence Address: LAMBERT & ASSOCIATES, P.L.L.C., 92 STATE STREET, BOSTON, MA, 02109-2004, US

(21) Appl. No.: 12/069,944

(22) Filed: Feb. 15, 2008

(51) Int. Cl. A01B 63/24

(52) U.S. Cl. 172/249

(57) ABSTRACT

A removeably attachable and multi-purpose tool and storage apparatus preferably for use with a utility tractor, wherein the storage apparatus allows for the placement and storage for a variety of tools and equipment to assist an individual in the performance of a multitude of tasks.

### BACKGROUND OF THE INVENTION

1. Field of the Invention

The instant invention relates generally to a multi-purpose tool and storage attachment, and in particular to a portable and removeably attachable multi-purpose tool and storage apparatus preferably for use with a utility tractor, allowing an individual to store a variety of tools within the apparatus for assistance in the performance of a variety of tasks along with providing the ability to tow a tailor and move/carry heavy objects among other things.

2. Description of the Related Art

In recent years, the use of tractors has grown in popularity and become extremely convenient for the average homeowner to perform a multitude of tasks and chores. In addition, the notion of the frequently thought of large “farm” tractor has given way to more versatile and smaller models that are appropriate in scale for use by both the farming and non-farming community. As such, these smaller versions most often contain one piece of equipment attached to the front end of the tractor, commonly a bucket, and some type of counterweight locatable on the back end of the tractor to offset the weight of the equipment located on the front end. A problem with these attachments is that each stands alone and only enables an individual to perform a specific task. In addition, more often than not, the back end of the tractor is rarely utilized beyond providing a counter-weight to any attachment at the front of the tractor.

Common tasks for an individual to utilize these “smaller” tractors include, but are not limited to landscaping, making trails, cutting chord wood, moving around trailers and being able to pull heavy objects with the assistance of a winch. In performing the above-mentioned tasks, an individual must utilize numerous different tools and devices, thus causing the individual to make repeated back and forth trips replacing tools once a task is complete. Therefore, an individual would be more productive in performing these tasks, if it were possible for these tractors to be able to carry the necessary tools and equipment; often times the back end of the tractor is rarely utilized, except for very specific tasks.

The instant invention relates to a multi-purpose removeable tool and storage attachment preferably for use on tractor to assist in the performance of a variety of tasks by allowing an individual to secure multiple pieces of equipment to the attachment thereby allowing the tractor to become an all-purpose vehicle, rather than be limited to the specific piece of equipment that is currently attachable. In addition to the storage aspect of the instant invention, the apparatus alone allows for the ability to perform tasks including but not limited to towing a trailer, housing a winch and carrying a chainsaw and chains for pulling heavy objects. Many devices have been developed to provide some type of assistance to individuals engaged in the operation of equipment for use with a tractor, especially individuals desiring to perform tasks around their home. Ultimately, it is the design goal for such an apparatus to provide both a removeably attachable tool and storage apparatus to assist individuals utilizing a tractor in performing a variety of tasks, wherein the apparatus utilizes a plurality of mechanisms to store each tool, along with serving as a tool capable of moving and carrying heaving objects among other things.

Presently, there are several storage devices that employ a variety of means to assist an individual in carrying devices or materials from one area to another. A large number of storage devices are known in the art, and in fact are in wide use in the industry. But there exists in the art no portable and removeably attachable multi-purpose storage device preferably for use with a tractor to assist an individual in the storage and transport of a variety of tools and equipment.

U.S. Pat. No. 5,433,357 to Alliff relates to load carrying vehicle accessories that are removably attachable to the rear fenders of a vehicle by the permanent attachment of mounting devices.

U.S. Design Patent No. D495,878 to Greene discloses a design for a tractor tool box with an indented top.

U.S. Pat. No. 4,596,347 to Hite discloses a rear mounted utility box for a lawn or garden tractor that includes a dumping pivot, wherein a removable housing rests on a horizontal U member of a frame, and contains a vertical plate for attachment to the frame.

U.S. Pat. No. 7,204,397 to Powell, et al. discloses a cargo container attachment for a small vehicle such as a lawn tractor, wherein the container is removable attached to the rear of the vehicle and includes a cargo box storage space with a pivotally mounted swingable tailgate.

U.S. Patent App. No. 2003/0150893 to Deutchman discloses a tractor tool caddy for carrying small and medium sized tools and equipment on a tractor while allowing the operator to keep his hands free.

U.S. Patent App. No. 2004/0211803 to Powell et al. discloses a vehicle attachment, such as a lawn or garden tractor which can be used for landscaping and maintenance.

In summary, investigation of these disclosed devices illustrates that presently, there is no single device known in the art or combination thereof that meets the requirements of a portable and removeably attachable storage device preferably for use with a tractor. With the need to be productive in today's ever changing world, there is the need for an apparatus that would assist an individual in being more productive, efficient and able to multi-task, well also creating a convenient means for the organization and storage of equipment.

### SUMMARY OF THE INVENTION

The instant invention, as described further herein, imparts a novel portable tool and storage apparatus, preferably for use with a tractor, which encompasses the advantages of other storage devices, but creates flexibility for the storage of multiple tools along with providing several built-in devices to allow for the performance of numerous tasks by attachment to a tractor by an individual, including towing a trailer, along with moving and carrying heavy objects. The instant invention as illustrated herein, is clearly not anticipated, rendered obvious, or even present in any of the prior art mechanisms, either alone or in any combination thereof.

The primary object of the instant invention is to provide a tool and storage apparatus capable of attachment to a tractor, wherein the storage apparatus contains a plurality of compartments to accommodate various tools utilized by an individual.

Another object of the instant invention is to provide a tool and storage apparatus capable of attachment to a tractor, wherein the storage apparatus is portable and removeably attachable in nature to allow an individual the option to selectively move the storage apparatus to different locations or vehicles for use.

Another object of the instant invention is to provide a tool and storage apparatus capable of attachment to a tractor, wherein the storage apparatus eliminates the need for an individual to travel back and forth during the performance of tasks for the appropriate tool; instead the instant invention allows an individual to place a multitude of tools onto the storage apparatus for placement on a tractor, enabling the individual to perform each task without interruption.

Another object of the instant invention is to provide a tool and storage apparatus capable of moving heavy objects and towing a trailer among other things, through the use of multiple pulling points locatable throughout the apparatus.

Another object of the instant invention is to provide a tool and storage apparatus capable of providing protection to the back of a standard utility during operation by creating a barrier against stationary and non-stationary objects including, but not limited to trees and rocks.

Another object of the instant invention is to provide a tool and storage apparatus capable of attachment and removal to a utility tractor through the use of a standard three-point hitch system.

Another object of the instant invention is to provide a tool and storage apparatus capable of interacting with a stand-alone cart for storage when the apparatus is not in use, and further to allow for an individual to transfer the apparatus do different locations with ease and efficiency.

There has thus been outlined, rather broadly, the more important features of the tool and storage apparatus for attachment to a tractor, in order that the detailed description thereof that follows may be better understand, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a diagrammatic perspective view of a multi-purpose tool and storage attachment displaying the overall base structural components of the apparatus prior to the addition of a plurality of mountable attachments to the base structure of the storage apparatus.

FIG. 2 is a diagrammatic perspective view of the multi-purpose tool and storage attachment displaying several additional components mountable to the apparatus including, but not limited to a tool box, a universal ball hitch preferably for attachment to a trailer and a storage space for liquid containers among other things.

FIG. 3 is a diagrammatic perspective view of the multi-purpose tool and storage attachment in use and preferably mountable to a tractor, allowing for the placement of a plurality of tools within the storage compartments of the apparatus.

FIG. 4 is a diagrammatic perspective view of the multi-purpose tool and storage attachment, displaying a back view of the apparatus, which comes in contact with the tractor during attachment through the three-point hitch system.

### DETAILED DESCRIPTION OF THE PREFERRED EMBODIMENTS

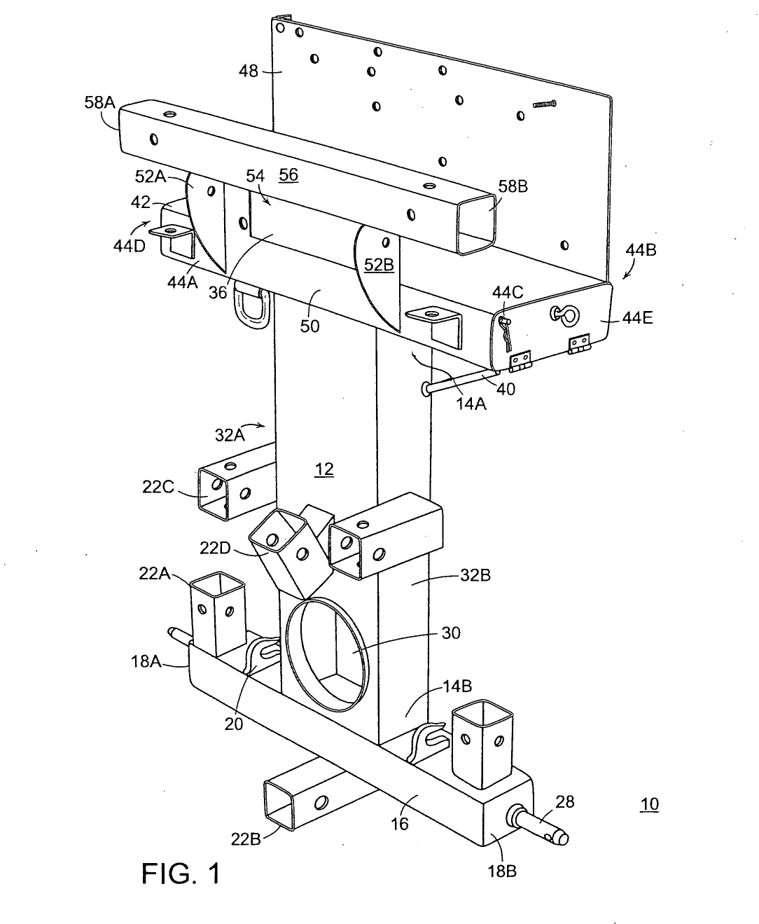

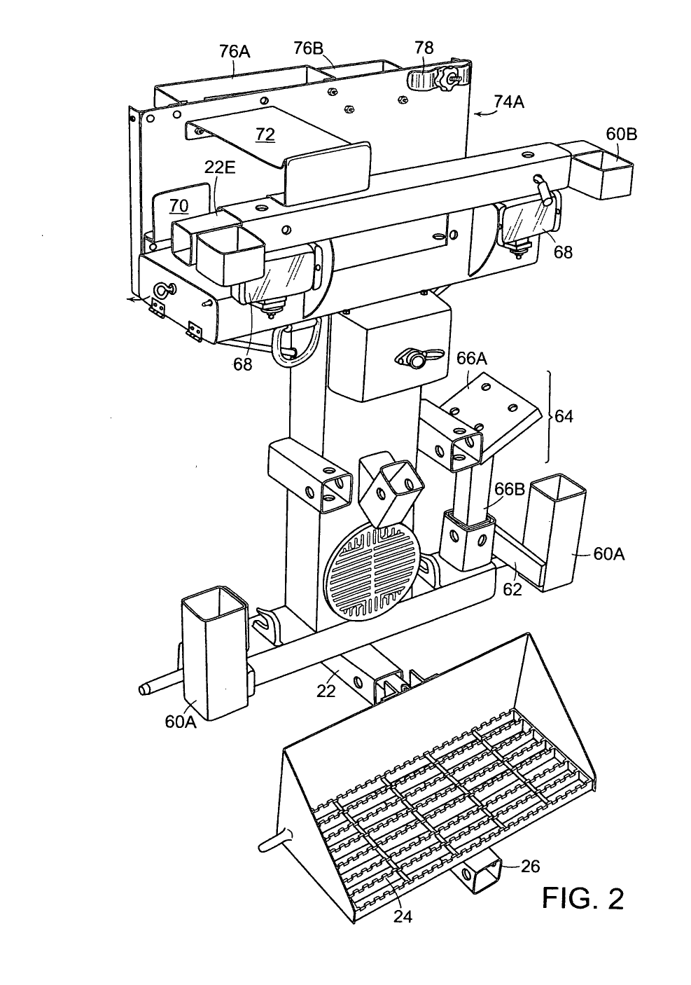

FIG. 1 illustrates a removeably attachable and multi-purpose tool and storage apparatus 10 having a main support member 12 comprising a top 14A and a bottom 14B. A base 16 having a first end 18A and a second end 18B is attachable to the bottom 14B of the main support member 12 such that the base 16 is preferably oriented in a perpendicular direction with respect to the orientation of the main support member 12. Furthermore, the bottom 14B of the support member 12 is preferably attachable to the center of the base 16. The base 16 preferably contains a plurality of tow hooks 20 attachable to said base 16 wherein at least one tow hook 20 is placeable near each end 18A and 18B of the base 16. Moreover, the base 16 preferably contains a plurality of receiver mechanisms 22A to house, hold or store a variety of tools and equipment wherein at least one receiver 22 is placeable near each end 18A and 18B of the base 16. In the preferred embodiment, each receiver 22 is locatable near each end 18A and 18B of the base 16, and each tow hook 20 is equidistantly disposable between each receiver 22 and the bottom 14B of the main support member 12. In addition, the base 16 includes at least one receiver mechanism 22B locatable in a perpendicular orientation to the base 16, allowing the receiver mechanism 22B to accommodate a trailer via a standard ball and hitch system; however the receiver 22B may also receive a carrying platform 24 (see FIG. 2) or other similar device.

In an alternate embodiment, when the apparatus 10 incorporates the carrying platform 24, a receiver mechanism 26 locatable on the carrying platform 24 is able to receive and accommodate a trailer through the ball and hitch system. Therefore, the instant invention allows for flexibility in both allowing the individual to utilize various attachments to the base 16 or other component, while not compromising the ability for one of the main functions of the apparatus 10 to be performed, namely towing a trailer or pulling other heavy objects. Furthermore, each end 18A and 18B of the base 16 includes at least one pulling point 28 extending outwardly there from, to enable an individual to attach cable, rope or similar material to assist an individual in towing and other activities.

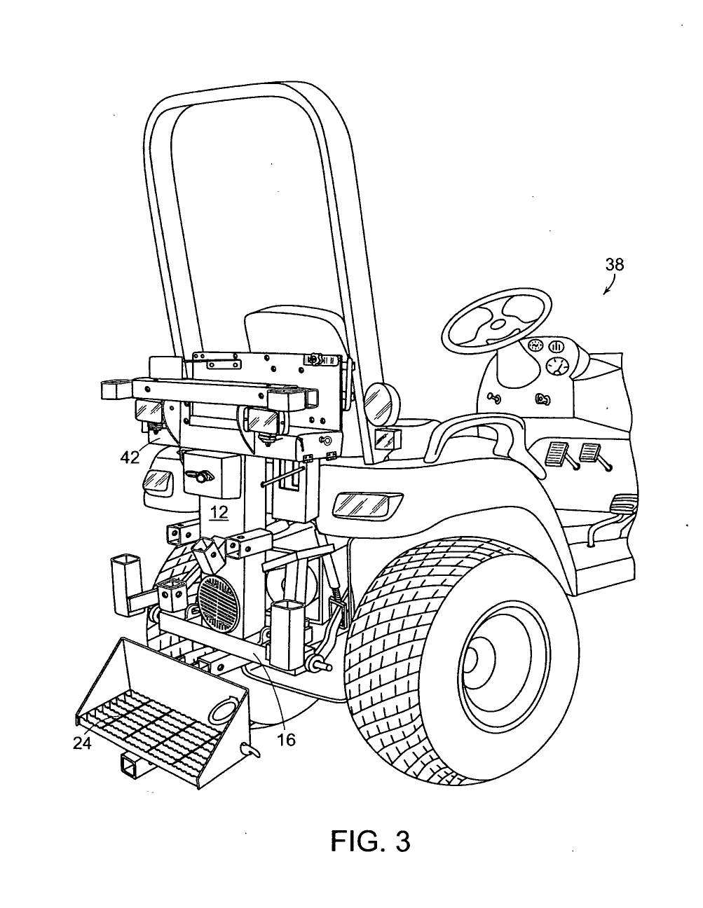

Moreover, the bottom 14B of the main support member 12 preferably contains a circular aperture 30 for access from a tractors 38 (see FIG. 3) power take off drive (not shown) through the apparatus 10 to a device such as a log splitter, wood chipper etc. Thus, a shaft would link from the tractor 38 through the apparatus 10 and hook to some type of device, such that a device that can be towed behind the tractor 38 and is power-take off driven may be utilized with the present invention. In alternate embodiments, a decorative cover is placeable over the aperture 30, when access to the power take off drive is not needed during a specific operation.

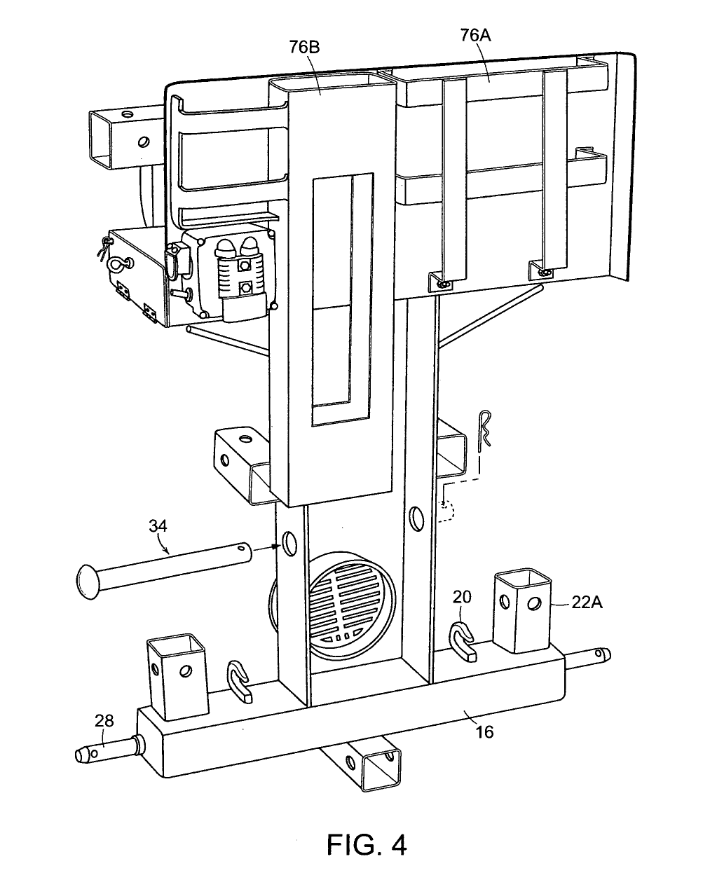

The main support member 12 also includes a first and second side 32A and 32B, wherein a plurality of receiver mechanisms 22C are locatable on each side and preferably are oriented in a perpendicular direction with regard to the main support member 12. The main support member 12 also includes a receiver mechanism 22D preferably locatable between the circular aperture 30 and the top 14A of the main support member 12, wherein the receiver mechanism 22D preferably is upwardly extending thirty degrees from a plane parallel to the main support member 12. In addition, the main support member 12 includes a removable pin 34 (see FIG. 4) that preferably is locatable through the center of the main support member 12 and constitutes one member of the three-point hitch system that enables attachment of the instant invention to a tractor (discussed in further detail below). A plurality of carrying devices 40 are preferably locatable on each side 32A and 32B of the main support member 12, each carrying device 40 preferably extending outwardly thirty degrees from a plane perpendicular to the main support member 12.

The present invention further includes a platform 42 attachable at the top 14A of the main support member 12, such that the platform 42 is oriented in a perpendicular direction with regard to the main support 12 and in a parallel direction with regard to the base 16. The platform 42 contains a front surface 44A, a back surface 44B, a top surface 44C, a first side 44D and a second side 44E, wherein each surface of the platform 42 enables attachment and placement of various tools and devices. Each side 44D and 44E of the platform 42 is hingedly connectable to the platform 42, such that a storage box 46 is accessible when either side 44D or 44E is in the open position. A back wall 48 is attachable to the back surface 44B of the platform such that the wall 48 extends upwardly from the platform 42 and is preferably oriented in a perpendicular direction with regard to the platform 42. Furthermore, a front wall 50 is attachable to the front surface of the platform 42, such that the front wall 50 extends upwardly from the platform 42 and is preferably oriented in a perpendicular direction with regard to the platform 42. A first front wall side 52A and a second front wall side 52B extend outwardly from the front wall 50, wherein each wall side 52A and 52B is preferably oriented in a perpendicular direction with regard to the front wall 50. Additionally, the front wall 50 includes an opening 54, preferably rectangular in shape such that, a device which is placeable on the top surface 44C of the platform 42 may be accessible for use by an individual, while simultaneously providing support for the device. In the preferred embodiment, a winch or like device will utilize this feature, wherein the winch and fair-lead, may utilize a control box that is attachable to the main support member, such that all three devices will work as one unit. Moreover, a utility support member 56 is attachable to the front wall 50 having a first end 58A and second 58B, and is supportable by each front wall side 52A and 52B, thereby allowing for several attachments to the utility support member 56.

FIG. 2 illustrates the removeably attachable apparatus 10, wherein the present invention includes several modifications to the base structure and additional carrying capacity for a variety of tools and devices. It is to be noted, that each of the below described attachments constitute interchangeable components in relation to the overall base structure of the apparatus, and as such the orientation of each attachment may be modified or adjusted depending on the need of an individual user. Therefore, while the preferred embodiment of the instant invention is further described below, changes to individual attachments, specifically orientation, have been contemplated and considered, although not presently shown. In the preferred embodiment, each end 18A and 18B of the base 16 includes a plurality of storage attachments 60A extending upwardly, wherein each storage attachment 60A is attachable to each receiver mechanism 22A locatable on the base 16 by a side bar 62. Preferably each storage attachment 60A is able to receive a variety of tools including, but not limited to shovels, rakes, and similar devices. The instant invention also includes a vice stand 64, wherein the stand includes a vice base 66A and a vice support 66B attachable to the vice base 66A and being receivable in one of the receiver mechanisms 22A locatable on the base 16 of the storage apparatus 10. The vice stand 64 is shown positionable in the stored position, wherein the stand 64 is received in the receiver mechanism 22A locatable on the base 16; however when in the useable position, the vice stand 64 is in communication with the receiver mechanism 22D extending outwardly from the main support member, preferably at a thirty degree angle. A plurality of lights 68 are locatable and attachable on the front surface 44A of the platform 42, wherein preferably there is one light 68 locatable near each end of the front surface 44A of the platform 42. In the preferred embodiment, each light 68 will include a switch and twelve-volt outlet for use and operation by an individual. At each end 58A and 58B of the utility support member 56, a receiver mechanism 22E is attachable and oriented in a parallel direction with regard to the utility support member 56. Additionally, a storage attachment 60B is locatable and attachable to each receiver mechanism 22E on the utility support member 56. In the preferred embodiment, each storage attachment 60B is in alignment with each corresponding receiver mechanism 22B locatable on the base 16 of the apparatus 10 such that an individual desiring to storage a tool, specifically with a long handle such as a rake, may pass the tool through both the storage attachment 60B and receiver mechanism 22B to properly secure the item.

Additionally, a holder 70 is locatable between the back surface 44B of the platform 42 and the back wall 48 and preferably the holder 70 includes a bolt mechanism for attachment to the platform 42, wherein the holder 70 preferably houses an axe or like device. Furthermore, a container placement device 72 is attachable to the back wall 48 of the platform 42, wherein the placement device 72 extends outwardly from the back wall 48 and preferably is oriented in a perpendicular direction with regard to the back wall 48. In the preferred embodiment, the container placement device 72 accommodates a gas can or other like container or liquid storage device, and is securable preferably by a plurality of nuts and bolts. The back wall 48 includes a back side 74A that includes a first carrying rack 76A preferably attachable by a plurality of nuts and bolts and suitable for storing a variety of items, including, but not limited to a first-aid kit. Furthermore, a second carry rack 76B is attachable to the back side 74A of the back wall is preferably locatable next to the first carrying rack 76A, using a plurality of nuts and bolts and is preferably suitable for the storage of a chainsaw, hedge trimmer or other similar tool that includes a long and narrow blade. Lastly, a scissor style cutter carrier 78 is attachable to the back wall 48 of the platform 42 and preferably is securable by a nut and bolt. In an alternate embodiment, the instant invention may incorporate a “head-ache” rack/work table to serve either as protection for the back of the tractor, or conversely to serve as a work table for an individual in conjunction with the instant invention. The rack may be connectable to the back of the apparatus 10 such that the rack will extend upwardly offering protection, whereas, the rack may be utilized as a work table by connecting to the receiver mechanisms 22E locatable on the utility support member 56.

Furthermore, the instant invention is designed to incorporate additional tools, attachments and devices, described herein but not shown. As such, this list is not exhaustive, and includes any and all obvious devices contemplated by those in the field or any individual utilizing the instant invention. Alternate embodiments may includes such devices a land anchor, outriggers, a pale holder (preferably five gallons and self-leveling), a plurality of drum carriers (preferably fifty-five gallon), a sand spread which is PTO driven, an engine hoist, a weed whacker, a high lift jack holder, a plurality of ballast weights for stability and support, a log splitter (preferably sixteen inches), a plurality of forks for pallets or like material, a fitted canvas cover for protection (preferably for protection from the elements), a removal cover for a winch housing (if included), a reversed quick hitch attachment, a gun case (preferably made of hard plastic) and a boulder scoop.

FIG. 3 illustrates the present invention in use, and preferably attachable to a tractor 38. While the storage apparatus 10 may be adaptable for a variety of tractors 38, the preferred embodiment utilizes a smaller version, although other sizes and model are contemplated and envisioned for usage with the instant invention. The preferred embodiment for attachment of the instant invention to a tractor utilizes a standard three-point hitch system, wherein one point of the system is attachable to each pulling point 28 extending outwardly from each end 18A and 18B of the base 16, and wherein the last point couples with the removeable pin 34 locatable throughout the center of the main support member 12. Thus, when the instant invention is attached to the tractor, through the use of hydraulics in conjunction with the three-point system, the tool and storage apparatus 10 may be raised or lowered depending on the specific task being preformed, from carrying a large rock to towing a trailer among other things. In addition, many standard tractors are relatively exposed on the back side, thereby offering no protection in the case of impacting with a non-stationary object; the instant invention is preferably constructed out of steel, thus creating a rugged, durable and sturdy device capable of performing a variety of tasks, while simultaneously acting as a barrier for the back of the tractor during operation.

FIG. 4 illustrates the instant invention shown from a back view wherein the removable pin 34 constitutes one point of the three point hitch system for attachment to the apparatus 10. In the preferred embodiment, the pin 34 is locatable through the main support member 12.

In use, the tool and storage apparatus 10 allows for the storage and placement of a multitude of tools and equipment for easy access during the performance of a variety of tasks, while also acting as a separate tool while attached to the tractor, which individuals may utilize when required to move or carry heavy objects, tow a trailer or similar device. Specifically, the instant invention enables an individual to utilize a tractor 38 in conjunction with the tool and storage apparatus 10, allowing for multiple tasks to be performed without having to replace or transfer separate pieces of equipment. The instant invention is especially helpful for individuals given the numerous storage compartments and holders, thereby solving the problem of utilizing a tractor 38 for one job at a time, whereas the storage apparatus 10 eliminates that issue. In addition to solving the problem of how to carry multiple tools at one time, the instant invention also functions as a stand-alone tool when attached to the tractor, in that through one of the many pulling points 28, or receiver mechanisms 22, an individual can perform numerous landscaping and/or farming tasks throughout their property, such as moving heavy objects, towing large vehicles, or any other activities that may be undertaken by an individual. Conversely, when the instant invention is not in operation, a storage cart may be utilized by an individual to both store the apparatus 10, along with transport the apparatus 10 to different locations with ease.

While several embodiments of the instant invention have been illustrated by way of example, it is apparent that further embodiments could be developed within the spirit and scope of the instant invention. However, it is to be expressly understood that such modifications and adaptations are within the spirit and scope of the instant invention, as set forth in the following claims.

What is claimed is:

1. A removeably attachable multi-purpose tool and storage apparatus comprising:
a main support member having a top, a bottom, a first side and second side;
a base having a first and a second end, wherein the base is attachable to the bottom of the main support member, wherein the base is oriented in a perpendicular direction with regard to the main support member; and
a platform attachable to the top of the main support member, wherein the platform includes a front surface, a back surface, a top surface, a first side and a second side.

2. The tool and storage apparatus of claim 1, wherein the base contains a plurality of tow hooks attachable to said base, wherein at least one tow hook is placeable near each end of the base.

3. The tool and storage apparatus of claim 2, wherein the base contains a plurality of receiver mechanisms to house, store or hold a variety of tools and equipment, wherein at least one receiver mechanism is locatable near each end of the base.

4. The tool and storage apparatus of claim 3, wherein each receiver mechanism is locatable near each end of the base and each tow hook is equidistantly disposable between each receiver mechanism and the bottom of the main support member.

5. The tool and storage apparatus of claim 4, wherein the base includes at least one receiver mechanism locatable in a perpendicular orientation with regard to the base, and wherein the receiver mechanism accommodates a trailer hitch.

6. The tool and storage apparatus of claim 5, wherein each end of the base includes at least one pulling point extending outwardly there from, to enable an individual to attach rope, cable or similar material for assistance in towing.

7. The tool and storage apparatus of claim 6, wherein the bottom of the main support member includes a circular aperture, wherein the circular aperture allows for accessibility from a tractor's power take off drive through the storage apparatus for attachment to devices selected from the group consisting of a log splitter and a wood chipper.

8. The tool and storage apparatus of claim 7, wherein a plurality of receiver mechanisms are locatable on each side of the main support member, wherein the receiver mechanisms locatable on each side of the main support member are oriented in a perpendicular direction with respect to the main support member.

9. The tool and storage apparatus of claim 8, wherein the main support member includes a receiver mechanism locatable between the circular aperture and the top of the main support member, such that the receiver mechanism upwardly extends thirty degrees from a plane parallel to the main support member, and wherein a plurality of carrying devices are locatable near the top of each side of the main support member, and wherein the main support member contains a removable pin locatable through the main support member for assistance during attachment to a tractor.

10. The tool and storage apparatus of claim 9, wherein each side of the platform is hingedly connectable to the platform, such that a storage box is accessible when either side is in the open position.

11. The tool and storage apparatus of claim 10, wherein a back wall is attachable and extending outwardly from the back surface of the platform and oriented in a perpendicular direction with regard to the platform.

12. The tool and storage apparatus of claim 11, wherein a front wall is attachable and extending outwardly from the front surface of the platform and oriented in a perpendicular direction with regard to the platform, and wherein the front wall includes a first and second front wall sides extending outwardly and oriented in a perpendicular direction with regard to the front wall.

13. The tool and storage apparatus of claim 12, wherein the front wall includes a rectangular opening, such that when a device is placeable on the top surface of the platform, the device is accessible for use by an individual while simultaneously providing support.

14. The tool and storage apparatus of claim 13, wherein a utility support member having a first end and second end is attachable to the front wall of the platform and is supportable by each front side wall.

15. The tool and storage apparatus of claim 14, wherein each end of the base includes a plurality of storage attachments extending upwardly, wherein each storage attachment is attachable to each receiver mechanism locatable on the base by a side bar.

16. The tool and storage apparatus of claim 15, further comprising a vice stand having a vice base and vice support, wherein the vice support is attachable to the vice base and receivable in one of the receiver mechanisms locatable on the base.

17. The tool and storage apparatus of claim 16, wherein a plurality of lights is locatable and attachable on the front surface of the platform and wherein each light locatable on the front surface of the platform includes an on/off switch and a twelve volt outlet for operation.

18. The tool and storage apparatus of claim 17, wherein a receiver mechanism is locatable at each end of the utility support member, wherein each receiver mechanism is oriented in a parallel direction with regard to the utility support member, and wherein a storage attachment is locatable and attachable to each receiver mechanism on the utility support member.

19. The tool and storage apparatus of claim 18, wherein a holder is locatable between the back surface of the platform and the back wall and wherein a container placement device is attachable to and extending outwardly from the back wall of the platform and oriented in a perpendicular direction with regard to the back wall.

20. The storage apparatus of claim 19, wherein the back wall includes a back side having a first carrying rack, a second carrying rack attachable to the back side and extending outwardly there from, and a scissor style cutter carrier attachable to the back wall of the platform and securable by a nut and bolt.
